(19) United States
(12) Patent Application Publication
(10) Pub. No.: US 2021/0276032 A1
(43) Pub. Date: Sep. 9, 2021

(54) Irrigation Stand Assembly

(71) Applicant: Paul Moore, Cuba, IL (US)

(72) Inventor: Paul Moore, Cuba, IL (US)

(21) Appl. No.: 16/808,000

(22) Filed: Mar. 3, 2020

(51) Int. Cl. B05B 15/625; B05B 15/628; B05B 15/63

(52) U.S. Cl. CPC B05B 15/625; B05B 15/63; B05B 15/628

(57) ABSTRACT

An irrigation stand assembly for hands free irrigation includes a handle has a first portion slidably engaging a second portion such that the handle has a telescopically adjustable length. A spray nozzle is coupled to the handle and the spray nozzle has an input and an output. The input is fluidly attachable to a fluid source to receive a fluid and the output sprays the fluid for irrigation. A stand is vertically orientable on a support surface and the stand releasably engages the handle for retaining the handle in an upright position. In this way the spray nozzle can be positioned on the support surface to irrigate the support surface without requiring the user to bend over.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to irrigation devices and more particularly pertains to a new irrigation device for hands free irrigation of a plant.

### (2) Description of Related Art Including Information Disclosed Under 37 CFR 1.97 and 1.98

The prior art relates to irrigation devices. The prior art discloses an irrigation wand that has an angled output to facilitate the base of a plant to be irrigated without requiring a user to bend over. Additionally, the prior art discloses a gutter flushing device that includes a hose and a nozzle that can be fluidly incorporated into a gutter for flushing the gutter with water. The prior art discloses a broom that includes a spray tube being positioned on a sweeping head of the broom. The prior art also discloses a spray nozzle that has an angled input to accommodate difficult fluid coupling orientations. In no instance does the prior art disclose an irrigation handle that includes a releasably attachable stand.

### BRIEF SUMMARY OF THE INVENTION

An embodiment of the disclosure meets the needs presented above by generally comprising a handle has a first portion slidably engaging a second portion such that the handle has a telescopically adjustable length. A spray nozzle is coupled to the handle and the spray nozzle has an input and an output. The input is fluidly attachable to a fluid source to receive a fluid and the output sprays the fluid for irrigation. A stand is vertically orientable on a support surface and the stand releasably engages the handle for retaining the handle in an upright position. In this way the spray nozzle can be positioned on the support surface to irrigate the support surface without requiring the user to bend over.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an irrigation stand assembly according to an embodiment of the disclosure.

FIG. 2 is a front phantom view of an embodiment of the disclosure.

FIG. 3 is a cross sectional view taken along line 3-3 of FIG. 1 of an embodiment of the disclosure.

FIG. 4 is a perspective in-use view of an embodiment of the disclosure showing a spray nozzle being hand held.

FIG. 5 is a perspective view of an embodiment of the disclosure being supported on a stand for hands free use.

### DETAILED DESCRIPTION OF THE INVENTION

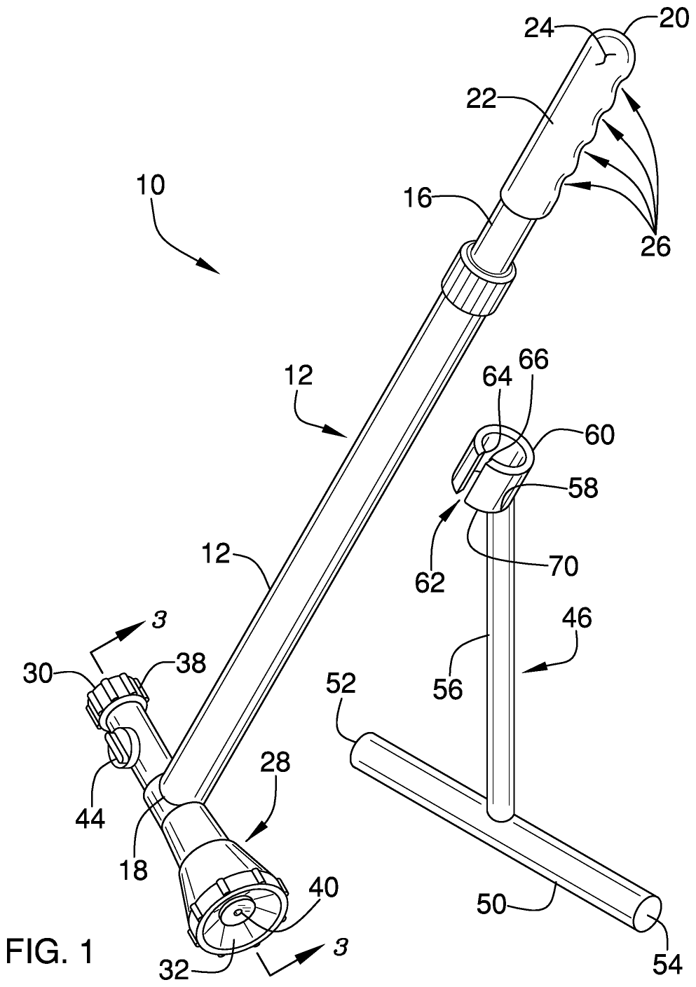

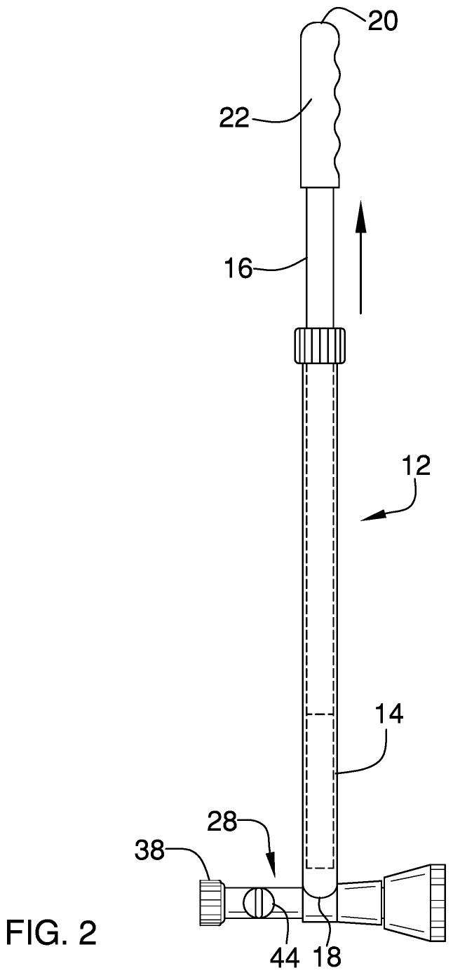

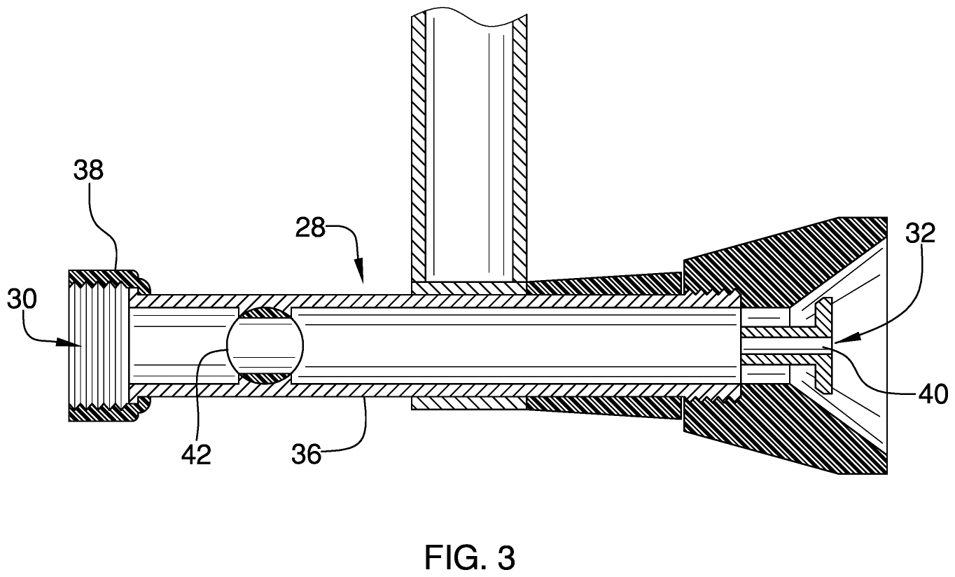

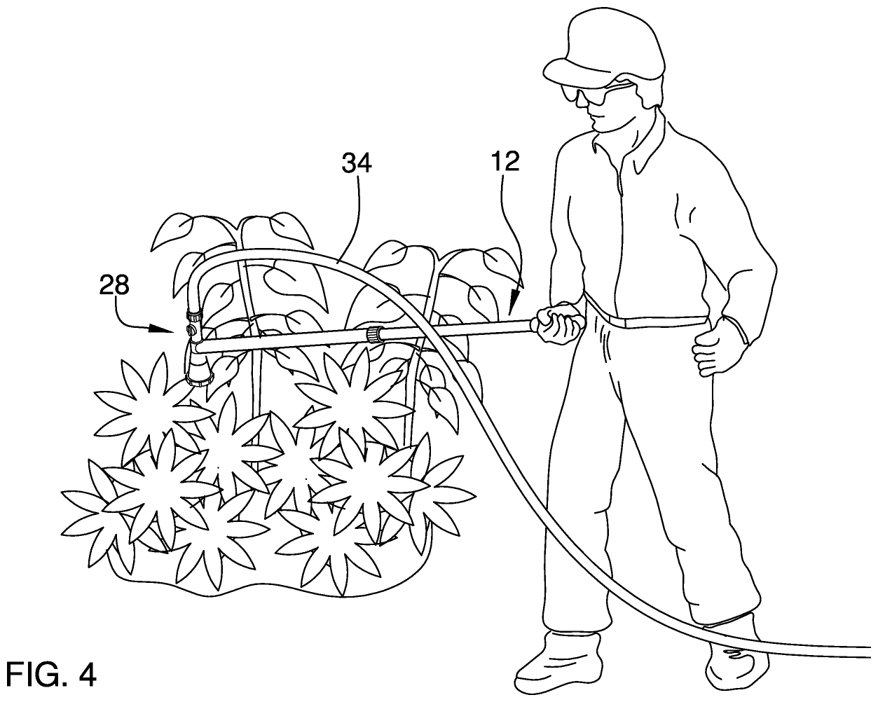

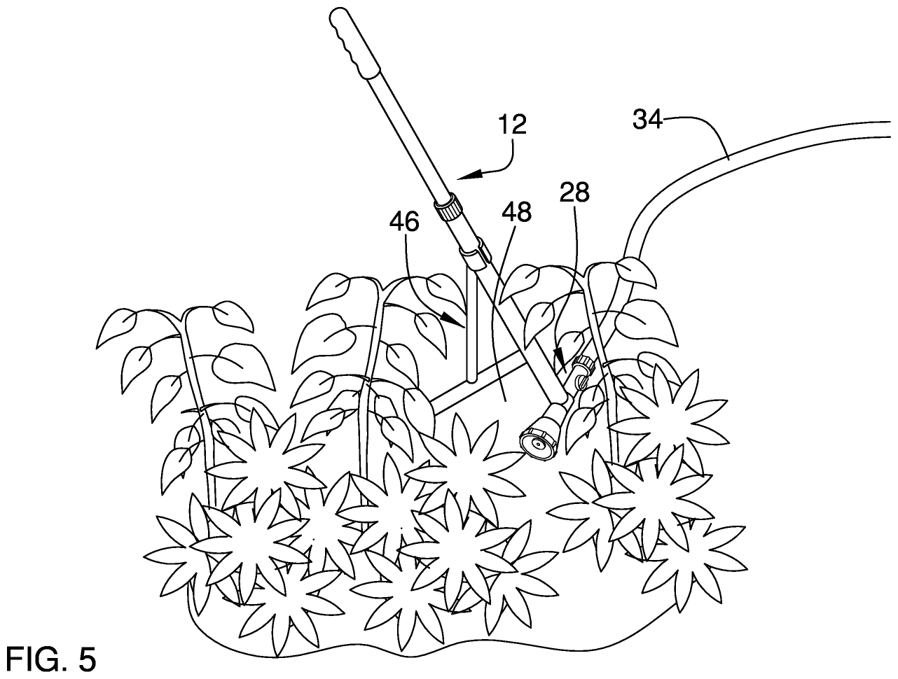

With reference now to the drawings, and in particular to FIGS. 1 through 5 thereof, a new irrigation device embodying the principles and concepts of an embodiment of the disclosure and generally designated by the reference numeral 10 will be described.

As best illustrated in FIGS. 1 through 5, the irrigation stand assembly 10 generally comprises a handle 12 that includes a first portion 14 that slidably engages a second portion 16 such that the handle 12 has a telescopically adjustable length. The first portion 14 has a lower end 18 and the second portion 16 has an upper end 20. A grip 22 is positioned around the second portion 16 for enhancing gripping the handle 12 and the grip 22 extends from the upper end 20 toward the first portion 14. The grip 22 has an outer surface 24 and the outer surface 24 has a plurality of finger indentations 26 thereon for accommodating a user's fingers when the grip 22 is gripped.

A spray nozzle 28 is coupled to the handle 12 and the spray nozzle 28 is positioned on the first portion 14 of the handle 12. The spray nozzle 28 is oriented to extend along an axis that is oriented perpendicular to an axis extending through the first portion 14 and the second portion 16 of the handle 12. The spray nozzle 28 has an input 30 and an output 32, and the input 30 is fluidly attachable to a fluid source 34 to receive a fluid. The output 32 is in fluid communication with the input 30 to spray the fluid for irrigation.

The spray nozzle 28 has an outer wall 36 extending between the input 30 and the output 32, and the outer wall 36 flares outwardly adjacent to the output 32. The input 30 comprises a female hose coupling 38 and the output 32 comprises a venturi 40 to spray the liquid outwardly therefrom. Additionally, the outer wall 36 is coupled to the lower end 18 of the first portion 14 of the handle 12. A valve 42 is movably coupled to the spray nozzle 28 and the valve 42 is in fluid communication with the input 30 and the output 32. The valve 42 is positionable in an open condition for passing fluid therethrough and the valve 42 is positionable in a closed condition for inhibiting fluid from passing therethrough. The valve 42 includes a knob 44 that is rotatably positioned on the outer wall 36 of the spray nozzle 28 to be manipulated by the user for turning the fluid on and off.

A stand 46 is vertically orientable on a support surface 48 and the stand 46 releasably engages the handle 12 for retaining the handle 12 in an upright 56 position. The spray nozzle 28 is positioned on the support surface 48 to irrigate the support surface 48 without requiring the user to bend over. The stand 46 comprises a base 50 that has a first end 52 and a second end 54, and the base 50 is positionable on the support surface 48. The support surface 48 may be the ground, soil in a plant pot or any other supports surface in which plants are growing. The stand 46 includes an upright 56 that is coupled to the base 50 and the upright 56 is centrally positioned between the first end 52 and the second end 54. The upright 56 is oriented to extend along a perpendicular axis with respect to an axis extending through the first end 52 and the second end 54 of the base 50 and the upright 56 has a distal end 58 with respect to the base 50.

The stand 46 includes a coupler 60 that is coupled to the distal end 58 of the upright 56. The coupler 60 has a slot 62 therein for insertably receiving the second portion 16 of the handle 12 when the base 50 is positioned on the support surface 48. The coupler 60 has a first portion 64 that is biased toward a second portion 66 to define the slot 62 extending therebetween. Moreover, the coupler 60 has a lower edge 70 and the lower edge 70 is coupled to the distal end 58 of the second portion 16 of the handle 12. The slot 62 extends along a line that is oriented at an angle with the perpendicular axis associated with the upright 56. In this way the coupler 60 can retain the handle 12 at an angle with respect to the upright 56.

In use, the input 30 of the spray nozzle 28 is fluidly coupled to the fluid source 34 and the handle 12 is gripped for directing the output 32 of the spray nozzle 28 in a desired direction. In this way irrigation can be accomplished without requiring the user to bend over. Moreover, the handle 12 can be attached to the upright 56 such that the spray nozzle 28 rests on the support surface 48. In this way the irrigation can be accomplished without requiring the user to hold the handle 12. The valve 42 can be placed in the open condition or the closed condition at any time for turning the flow of fluid on and off.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An irrigation stand assembly having a spray nozzle being supportable by a stand to facilitate said spray nozzle to be aligned with the ground for irrigation, said assembly comprising:
a handle having a first portion slidably engaging a second portion such that said handle has a telescopically adjustable length;
a grip being positioned around said second portion for enhancing gripping said handle, said grip extending from said upper end toward said first portion, said grip having an outer surface, said outer surface having a plurality of finger indentations thereon for accommodating a user's fingers when said grip is gripped;
a spray nozzle being coupled to said handle, said spray nozzle being positioned on said first portion, said spray nozzle being oriented to extend along an axis being oriented perpendicular to an axis extending through said first portion and said second portion of said handle, said spray nozzle having an input and an output, said input being fluidly attachable to a fluid source wherein said spray nozzle is configured to receive a fluid, said output being in fluid communication with said input wherein said output is configured to spray the fluid for irrigation;
a valve being movably coupled to said spray nozzle, said valve being in fluid communication with said input and said output, said valve being positionable in an open condition for passing fluid therethrough, said valve being positionable in a closed condition for inhibiting fluid from passing therethrough; and
a stand being vertically orientable on a support surface, said stand releasably engaging said handle for retaining said handle in an upright position having said spray nozzle being positioned on the support surface wherein said spray nozzle is configured to irrigate the support surface without requiring the user to bend over.

2. The assembly according to claim 1, wherein said first portion has a lower end, said spray nozzle having an outer wall extending between said input and said output, said outer wall flaring outwardly adjacent to said output, said input comprising a female hose coupling, said output comprising a venturi wherein said output is configured to spray the liquid outwardly therefrom, said outer wall being coupled to said lower end of said first portion of said handle.

3. The assembly according to claim 1, wherein said stand comprises:
a base having a first end and a second end, said base being positionable on the support surface; and
an upright being coupled to said base, said upright being centrally positioned between said first end and said second end, said upright being oriented to extend along a perpendicular axis with respect to an axis extending through said first end and said second end of said base, said upright having a distal end with respect to said base.

4. The assembly according to claim 5, further comprising a coupler being coupled to said distal end of said upright, said coupler having a slot therein for insertably receiving said second portion of said handle when said base is positioned on the support surface, said coupler having a first portion being biased toward a second portion to define a slot extending therebetween.

5. The assembly according to claim 4, further comprising said coupler having a lower edge, said lower edge being coupled to said distal end of said of said second portion of said handle having said slot extending along a line being oriented at an angle with said perpendicular axis associated with said upright thereby facilitating said coupler to retain said handle at an angle with respect to said upright.

6. An irrigation stand assembly having a spray nozzle being supportable by a stand to facilitate said spray nozzle to be aligned with the ground for irrigation, said assembly comprising:
a handle having a first portion slidably engaging a second portion such that said handle has a telescopically adjustable length, said first portion having a lower end, said second portion having an upper end;
a grip being positioned around said second portion for enhancing gripping said handle, said grip extending from said upper end toward said first portion, said grip having an outer surface, said outer surface having a plurality of finger indentations thereon for accommodating a user's fingers when said grip is gripped;
a spray nozzle being coupled to said handle, said spray nozzle being positioned on said first portion, said spray nozzle being oriented to extend along an axis being oriented perpendicular to an axis extending through said first portion and said second portion of said handle, said spray nozzle having an input and an output, said input being fluidly attachable to a fluid source wherein said spray nozzle is configured to receive a fluid, said output being in fluid communication with said input wherein said output is configured to spray the fluid for irrigation, said spray nozzle having an outer wall extending between said input and said output, said outer wall flaring outwardly adjacent to said output, said input comprising a female hose coupling, said output comprising a venturi wherein said output is configured to spray the liquid outwardly therefrom, said outer wall being coupled to said lower end of said first portion of said handle;
a valve being movably coupled to said spray nozzle, said valve being in fluid communication with said input and said output, said valve being positionable in an open condition for passing fluid therethrough, said valve being positionable in a closed condition for inhibiting fluid from passing therethrough, said valve including a knob being rotatably positioned on said outer wall of said spray nozzle wherein said knob is configured to be manipulated by the user for turning the fluid on and off; and
a stand being vertically orientable on a support surface, said stand releasably engaging said handle for retaining said handle in an upright position having said spray nozzle being positioned on the support surface wherein said spray nozzle is configured to irrigate the support surface without requiring the user to bend over, said stand comprising:
a base having a first end and a second end, said base being positionable on the support surface;
an upright being coupled to said base, said upright being centrally positioned between said first end and said second end, said upright being oriented to extend along a perpendicular axis with respect to an axis extending through said first end and said second end of said base, said upright having a distal end with respect to said base; and
a coupler being coupled to said distal end of said upright, said coupler having a slot therein for insertably receiving said second portion of said handle when said base is positioned on the support surface, said coupler having a first portion being biased toward a second portion to define a slot extending therebetween, said coupler having a lower edge, said lower edge being coupled to said distal end of said of said second portion of said handle having said slot extending along a line being oriented at an angle with said perpendicular axis associated with said upright thereby facilitating said coupler to retain said handle at an angle with respect to said upright.
